(19) United States
(12) Patent Application Publication
(10) Pub. No.: US 2026/0252257 A1
(43) Pub. Date: Aug. 27, 2026

(54) ROBOT CONTROL DEVICE, CONTROL METHOD, AND RECORDING MEDIUM

(71) Applicant: FANUC CORPORATION, Minamitsuru-gun, Yamanashi (JP)

(72) Inventor: Keisuke NAGANO, Yamanashi (JP)

(21) Appl. No.: 18/872,529

(22) PCT Filed: Jun. 15, 2022
(86) PCT No.: PCT/JP2022/023979

§ 371 Date: Dec. 6, 2024

(51) Int. Cl. G06F 3/06

(52) U.S. Cl. CPC G06F 3/0655; G06F 3/0604; G06F 3/0673

(57) ABSTRACT

The present invention enables high-speed reading/writing of data even when a robot control device does not have a cache-line function. This robot control device comprises a processor, a volatile memory, and a non-volatile memory. The processor: secures, in the volatile memory, a cache memory area having the same size as a prescribed area of the non-volatile memory; writes data in the prescribed area of the non-volatile memory as well in the case when data is to be written in the cache memory area of the volatile memory by software control; and reads, in the case when data is to be read, the data from the volatile memory.

### TECHNICAL FIELD

The present invention relates to a robot control device, a control method, and a recording medium.

### BACKGROUND ART

Generally, in order to improve a data reading/writing speed, there is a cache memory which is fast in reading/writing and saves frequently-used data in advance, such as an SRAM.

The data in the cache memory is written to a non-volatile memory, such as a FLASH memory (registered trademark), at certain timing. In one control method, a so-called cache line is employed in a correspondence relationship between the cache memory and the non-volatile memory.

In operation of the cache memory, cache line control is complicated and it takes time to process the cache line. For these reasons, a cache line control function of hardware of a processor is used. The hardware performs the processing in the background in parallel with execution of a program, and influence on execution of the program is small.

In order to reproduce a previous state even if a robot control device is powered off due to, e. g., blackout during operation of a robot, the robot control device constantly saves data in the non-volatile memory to hold data immediately before the power-off. For example, see Patent Document 1.

The robot control device needs to save data in the non-volatile memory in order to normally recover the data after, e.g., the blackout, but it has been known that the time of data reading from the non-volatile memory and data writing to the non-volatile memory is long. Thus, the data reading/writing speed greatly influences the time of execution of the program by the processor. For this reason, the robot control device normally includes a volatile memory which is faster in data reading/writing than the non-volatile memory, and in a case where the volatile memory shorter in the reading/writing time is used as the cache memory, the program execution time can be shortened.

### CITATION LIST

### Patent Document

Patent Document 1: Japanese Unexamined Patent Application, Publication No. 2013-198958

### DISCLOSURE OF THE INVENTION

### Problems to be Solved by the Invention

However, the robot control device may have a hardware configuration to which the cache line function is not applicable.

For this reason, there has been demanded high-speed data reading/writing processing even in a case where the robot control device has no cache line function.

### Means for Solving the Problems

One aspect of a robot control device of the present disclosure is a robot control device including a processor, a non-volatile memory, and a volatile memory. The processor secures, in the volatile memory, a cache memory area with a size equal to that of a predetermined area in the non-volatile memory, and also writes data to the predetermined area in the non-volatile memory when writing the data to the cache memory area in the volatile memory by software control, and reads data from the volatile memory when reading the data.

One aspect of a control method of the present disclosure is a control method by a robot control device including a processor, a volatile memory, and a non-volatile memory. The control method includes a step of the processor securing, in the volatile memory, a cache memory area with a size equal to that of a predetermined area in the non-volatile memory, and a step of the processor also writing data to the predetermined area in the non-volatile memory when writing the data to the cache memory area in the volatile memory by software control, and reading data from the volatile memory when reading the data.

One aspect of a recording medium of the present disclosure is a processor readable recording medium having recorded thereon a program causing a processor of a robot control device including a non-volatile memory and a volatile memory to secure, in the volatile memory, a cache memory area with a size equal to that of a predetermined area in the non-volatile memory and to also write data to the predetermined area in the non-volatile memory when writing the data to the cache memory area in the volatile memory by software control and read data from the volatile memory when reading the data.

### Effects of the Invention

According to one aspect, the high-speed data reading/writing processing can be performed even in a case where the robot control device has no cache line function.

### BRIEF DESCRIPTION OF THE DRAWINGS

FIG. 1 is a diagram showing one example of a hardware configuration of a robot control device according to one embodiment;

FIG. 2 is a diagram showing one example of a relationship between an address space in a non-volatile memory and an address space in a volatile memory;

FIG. 3 is a flowchart for describing writing processing in the robot control device; and

FIG. 4 is a flowchart for describing reading processing in the robot control device.

### PREFERRED MODE FOR CARRYING OUT THE INVENTION

Hereinafter, a robot control device according to one embodiment will be described in detail with reference to the figures.

### One Embodiment

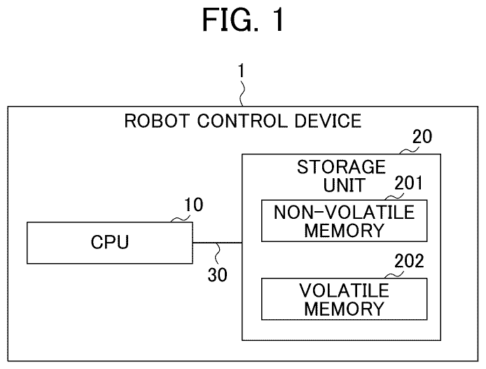

FIG. 1 is a diagram showing one example of a hardware configuration of the robot control device according to one embodiment.

The robot control device 1 is a robot control device well-known by those skilled in the art, and may be directly connected to a not-shown robot via a not-shown connection interface. Alternatively, the robot control device 1 may be connected to the not-shown robot via a not-shown network such as a local area network (LAN) or the Internet. In this case, the robot control device 1 may include a not-shown communication unit for communication with the not-shown robot via such connection.

For example, the robot control device 1 generates a command based on a robot program created using, e.g., a not-shown teaching control panel, and transmits the generated command to the robot (not shown). In this manner, the robot control device 1 controls operation of the not-shown robot.

As shown in FIG. 1, the robot control device 1 has a CPU 10 and a storage unit 20. The CPU 10 and the storage unit 20 are communicably connected to each other via a bus 30.

The CPU 10 is a processor that controls the robot control device 1 as a whole. The CPU 10 reads a system program of an OS and application programs of various types of software from the later-described storage unit 20 via the bus 30, and controls the entirety of the robot control device 1 according to the system program and the application programs.

The storage unit 20 has a non-volatile memory 201 and a volatile memory 202.

The non-volatile memory 201 is, e.g., a solid state drive (SSD), a hard disk drive (HDD), or an SRAM including a backup power source, and stores the OS, the various types of software, and files for various settings.

The OS is, for example, an operating system (OS) or a system program executed in the robot control device 1.

The various types of software are, for example, software including an operation program for the not-shown robot and application programs for implementing various functions of the robot control device 1 such as cache line control.

The files for various settings are, for example, software setting files in the various types of software.

The volatile memory 202 is, for example, a random access memory (RAM), and various files are loaded into the volatile memory 202 from the non-volatile memory 201 as necessary and are used for, e.g., calculation by the CPU 10.

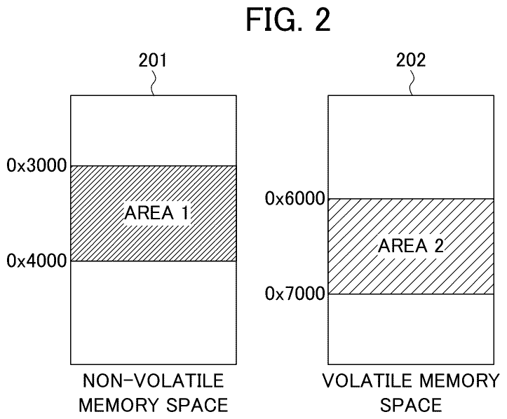

Note that for caching data from the non-volatile memory 201 to the volatile memory 202 by software control, the CPU 10 secures (sets) address spaces with the same data size in the non-volatile memory 201 and the volatile memory 202, as shown in FIG. 2. In FIG. 2, for example, an address space (area 1) from “0x3000” to “0x4000” is secured (set) as a predetermined area in the non-volatile memory 201, and an address space (area 2) from “0x6000” to “0x7000” is secured (set) as a cache memory area in the volatile memory 202. That is, the address space as the area 1 secured in the non-volatile memory 201 and the address space as the area 2 secured in the volatile memory 202 are in one-to-one correspondence, and therefore, the CPU 10 can constantly derive a corresponding address of the volatile memory 202 with a predetermined offset from the address of the non-volatile memory 201. Moreover, the CPU 10 can constantly derive a corresponding address of the non-volatile memory 201 with a predetermined offset from the address of the volatile memory 202.

When writing data to the address space as the area 2 secured in the volatile memory 202 as a caching destination, the CPU 10 also writes the data to the corresponding area 1 secured in the non-volatile memory 201. On the other hand, when reading data, the CPU 10 reads cached data from the volatile memory 202.

The CPU 10 fixes a cache line by fixing data to the address spaces with the same size in the non-volatile memory 201 and the volatile memory 202 as the cache memory, and performs write-through. With this configuration, even a robot control device having no cache line function can perform control equivalent to cache line control.

### Writing Processing in Robot Control Device 1

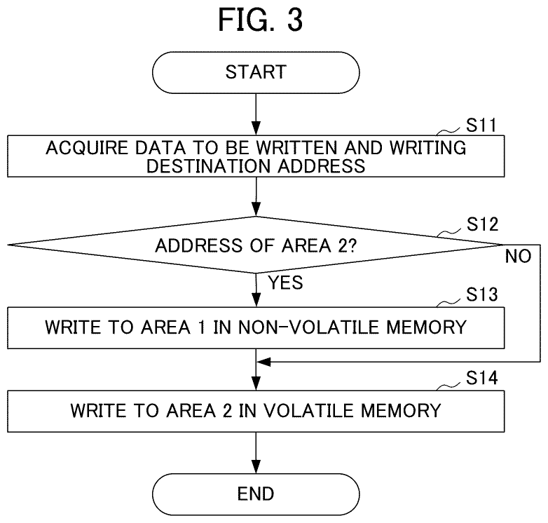

Next, the flow of writing processing in the robot control device 1 will be described with reference to FIG. 3.

FIG. 3 is a flowchart for describing the writing processing in the robot control device 1. The flow described here is executed in every reception of data to be written to the storage unit 20.

In Step S11, the CPU 10 acquires the data to be written to the storage unit 20 and a writing destination address.

In Step S12, the CPU 10 determines whether or not the writing destination address is the address of the area 2 secured in the volatile memory 202. In a case where the writing destination address is the address of the area 2 secured in the volatile memory 202, the CPU 10 derives the corresponding address of the area 1 secured in the non-volatile memory 201, and the processing proceeds to Step S13. On the other hand, in a case where the writing destination address is not the address of the area 2 secured in the volatile memory 202, the processing proceeds to Step S14.

In Step S13, the CPU 10 writes the data received in Step S11 to the area 1 secured in the non-volatile memory 201.

In Step S14, the CPU 10 writes the data received in Step S11 to the address of the volatile memory 202 acquired in Step S11.

### Reading Processing in Robot Control Device 1

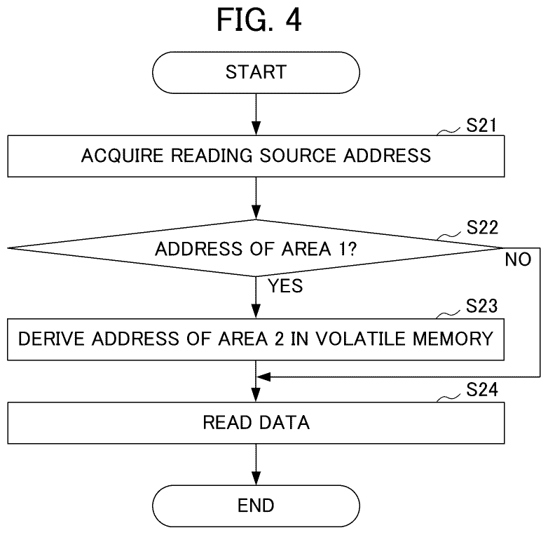

Next, the flow of reading processing in the robot control device 1 will be described with reference to FIG. 4.

FIG. 4 is a flowchart for describing the reading processing in the robot control device 1. The flow described here is executed in every reception of a data reading instruction.

In Step S21, the CPU 10 acquires the data reading instruction and a reading source address in the storage unit 20.

In Step S22, the CPU 10 determines whether or not the reading source address is the address of the area 1 secured in the non-volatile memory 201. In a case where the reading source address is the address of the area 1 secured in the non-volatile memory 201, the processing proceeds to Step S23. On the other hand, in a case where the reading source address is an address other than the address of the area 1 secured in the non-volatile memory 201, the processing proceeds to Step S24.

In Step S23, the CPU 10 derives the address of the area 2 secured in the volatile memory 202, which corresponds to the reading source address.

In Step S24, the CPU 10 reads the data of the address acquired in Step S21 or the address derived in Step S23 from the storage unit 20.

As described above, the robot control device 1 according to one embodiment is configured such that the area 1 and the area 2 as the address spaces with the same data size are secured (set) in advance in the non-volatile memory 201 and the volatile memory 202 and are in one-to-one correspondence. With this configuration, even in a case where the robot control device has no cache line function, high-speed data reading/writing processing can be performed.

Moreover, the robot control device 1 is implemented by the software that caching can be performed even in a hardware configuration to which caching is not applicable.

Further, the robot control device 1 can quickly perform caching without cache line control.

One embodiment has been described above, but the robot control device 1 is not limited to the above-described embodiment and changes, modifications, etc. are made within a scope in which the object can be achieved.

Note that each function of the robot control device 1 in one embodiment may be implemented by hardware, software, or a combination thereof. Here, implementation by the software means implementation by reading and execution of a program by a computer.

The program can be stored using various types of non-transitory computer readable media and be supplied to the computer. The non-transitory computer readable media include various types of tangible storage media. Examples of the non-transitory computer readable medium include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a RAM). The program may be supplied to the computer by various types of transitory computer readable media. Examples of the transitory computer readable medium include an electric signal, an optical signal, and an electromagnetic wave. The transitory computer readable medium can supply the program to the computer via a wired communication path such as an electric wire or an optical fiber or a wireless communication path.

Note that the steps of describing the program recorded on the recording medium include not only processing performed in chronological order, but also processing executed in parallel or separately.

In other words, the robot control device, control method, and recording medium of the present disclosure may include various embodiments having the following configurations.
(1) The robot control device 1 of the present disclosure is the robot control device including the CPU 10, the non-volatile memory 201, and the volatile memory 202. The CPU 10 secures, in the volatile memory 202, the cache memory area with the size equal to that of the predetermined area in the non-volatile memory 201, and also writes data to the predetermined area in the non-volatile memory 201 when writing the data to the cache memory area in the volatile memory 202 by software control, and reads data from the volatile memory 202 when reading the data.

According to the robot control device 1, the high-speed data reading/writing processing can be performed even in a case where the robot control device has no cache line function.
(2) In the robot control device 1 according to (1), the predetermined area in the non-volatile memory 201 and the cache memory area in the volatile memory 202 may be the address spaces in one-to-one correspondence, and the CPU 10 may constantly derive the corresponding address of the non-volatile memory 201 with the predetermined offset from the address of the volatile memory 202.
(3) The control method of the present disclosure is the control method by the robot control device 1 including the CPU 10, the non-volatile memory 201, and the volatile memory 202. The control method includes a step of the CPU 10 securing, in the volatile memory 202, the cache memory area with the size equal to that of the predetermined area in the non-volatile memory 201, and a step of also writing data to the predetermined area in the non-volatile memory 201 when writing the data to the cache memory area in the volatile memory 202 by software control, and reading data from the volatile memory 202 when reading the data.

According to the control method, effects equivalent to those of (1) can be provided.
(4) The recording medium of the present disclosure is the recording medium readable by the CPU 10 and having recorded thereon the program causing the CPU 10 of the robot control device 1 including the non-volatile memory 201 and the volatile memory 202 to secure, in the volatile memory 202, the cache memory area with the size equal to that of the predetermined area in the non-volatile memory 201 and to also write data to the predetermined area in the non-volatile memory 201 when writing the data to the cache memory area in the volatile memory 202 by software control and read data from the volatile memory when reading the data.

According to the recording medium, effects equivalent to those of (1) can be provided.

### EXPLANATION OF REFERENCE NUMERALS

1 Robot Control Device
10 CPU
20 Storage Unit
201 Non-Volatile Memory
202 Volatile Memory
30 Bus

1. A robot control device comprising:
a processor;
a non-volatile memory; and
a volatile memory,
wherein the processor
secures, in the volatile memory, a cache memory area with a size equal to that of a predetermined area in the non-volatile memory, and
also writes data to the predetermined area in the non-volatile memory when writing the data to the cache memory area in the volatile memory by software control, and reads data from the volatile memory when reading the data.

2. The robot control device according to claim 1, wherein the cache memory area in the volatile memory and the predetermined area in the non-volatile memory are address spaces in one-to-one correspondence, and the processor constantly derives a corresponding address of the non-volatile memory with a predetermined offset from an address of the volatile memory.

3. A control method by a robot control device including a processor, a volatile memory, and a non-volatile memory, comprising:
a step of the processor securing, in the volatile memory, a cache memory area with a size equal to that of a predetermined area in the non-volatile memory; and
a step of the processor also writing data to the predetermined area in the non-volatile memory when writing the data to the cache memory area in the volatile memory by software control, and reading data from the volatile memory when reading the data.

4. A non-transitory computer readable medium having recorded thereon a program causing
a processor of a robot control device including a non-volatile memory and a volatile memory to
secure, in the volatile memory, a cache memory area with a size equal to that of a predetermined area in the non-volatile memory, and
also write data to the predetermined area in the non-volatile memory when writing the data to the cache memory area in the volatile memory by software control, and read data from the volatile memory when reading the data.
